(19) United States
(12) Patent Application Publication
(10) Pub. No.: US 2011/0208604 A1
(43) Pub. Date: Aug. 25, 2011

(54) Media Delivery System for an Automobile by the Use of Voice Input Device and Head-Up Display

(76) Inventor: Yang Pan, Singapore (SG)

(21) Appl. No.: 12/709,457

(22) Filed: Feb. 20, 2010

(51) Int. Cl. G06F 19/00; G02B 27/01; G10L 15/00; G01C 21/36; G06Q 30/00

(52) U.S. Cl. 705/26.1; 359/630; 704/275; 701/36; 701/209; 704/E15.001

(57) ABSTRACT

System and method for delivering media assets to a user of an automobile is disclosed. The system comprises a voice input device and a voice recognition device. The system further comprises a head-up display device for displaying metadata of the media assets on a windshield of the automobile. After a user's input for one or a group of media assets is received, a list of metadata of the media assets is displayed on the windshield. The system plays back the selected media asset through the use of a media delivery unit after the selection is received by the voice input device. A driving route may also be displayed on the windshield.

### CROSS-REFERENCE TO RELATED APPLICATIONS

Not applicable.

### BACKGROUND

1. Field of Invention

This invention relates generally to media asset delivery. More specifically, the invention describes system and method of media asset delivery for a user of a vehicle such as an automobile.

2. Description of Prior Art

Today, many individuals have extensive audio and video collections. Furthermore, with the advent of new media for audio and video storage, users have many more options in which to transport their favorite songs, pictures and videos. Many automobile stereo systems are equipped with devices for playing digitally media assets. Such devices may include compact disc (CD) players, digital video disc (DVD) players and MP3 players.

A modern automobile is typically equipped with a touch-screen type of device near the seat of the driver for displaying user selectable items. The user may employ the device to select a favorite song for playing back using an in-vehicle media player. The user may also employ the device to view a driving route when a GPS (Global Positioning System) navigation device is included.

However, the problem with such a device is that often times a driver may need to concentrate on a driving situation. It may result in safety related risks if the driver needs to angle down looking at lower instruments while driving.

Therefore, it is desirable to have a safe method for a driver of an automobile to operate an in-vehicle media delivery system by minimizing distraction from driving the vehicle.

### SUMMARY OF THE INVENTION

It is an object of the present invention to provide system and method for delivering media assets in a vehicle with greatly improved safety.

The system comprises a media delivery unit such as a speaker system, a processor and a storage unit. The system may also comprise an input device and an output device as used in conventional automobile stereo systems. The invention is characterized by that a HUD (Head-Up Display) device is used to display user selectable items on a windshield of the automobile. Therefore, the user may view the displayed content while remaining concentrated on the front view while driving. The invention is further characterized by utilizing a voice input device. After the device receives the user's voice input of one or a group of media assets, the processor controls an operation of displaying metadata of associated media assets on the windshield by using the HUD. The user selects at least one media asset by using his or her voice. The system plays back the selected media asset after the voice input device receives the user's selection and a voice recognition device translates the input to an instruction recognizable by the processor.

According to one implementation of the present invention, each displayed metadata of the media asset may be assigned a number in a sequential manner. The user may select one of the assets for playing back by reading the associated number.

According to one embodiment of the present invention, the system comprises a media player. According to another embodiment of the present invention, the system further comprises a GPS navigation device. A driving route may be displayed on the windshield using the HUD. The user may use his or her voice to control the system to operate as a media player or as a GPS navigation system.

The media assets may be stored in the storage unit in vehicle. The media assets may also be stored in a server connected to the system through a communication network such as the Internet. The user may purchase a displayed asset before it is played back.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary in-vehicle media delivery system;

FIG. 2 is a schematic diagram illustrating that metadata of a list of user selectable media assets is displayed on the windshield of a vehicle by employing the HUD device;

FIG. 3 is a flowchart illustrating the operation of the in-vehicle media delivery system;

FIG. 4 is a schematic diagram illustrating an exemplary in-vehicle media delivery system including a GPS navigation device;

FIG. 5 is a flowchart illustrating the operation of the in-vehicle media delivery system including GPS navigation device;

FIG. 6 is a flowchart illustrating the operation of the in-vehicle media delivery system connected to a server through the Internet.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The present disclosure uses an automobile as an exemplary case to illustrate the inventive concept. The inventive concept can also be applied to other types of vehicles including a watercraft and an aircraft.

A HUD is any transparent display that presents data without requiring the user to look away from his or her usual viewpoint. The origin of the name stems from the user being able to view information with his or her head “up” and looking forward, instead of angled down looking at lower instruments. Although they were initially developed for military aviation, HUDs are now used in commercial aircraft, automobiles, and other applications.

General Motors began using head-up displays in 1988 with the first color display appearing in 2001 on the Corvette. In 2003, BMW became the first European manufacturer to offer HUD. The displays are becoming increasingly available in production cars, and usually offer speedometer, tachometer, and navigation system displays. Night vision information is also displayed via HUD on certain General Motors, Honda, Toyota and Lexus vehicles. Other manufactures such as Citroën, and Nissan currently offer some form of HUD system. Motorcycle helmet HUDs are also commercially available.

The audio assets are used in the present disclosure only in an exemplary manner to illustrate the inventive concept. The inventive concept may also be implemented to deliver other type of media assets such as video files. An automobile may be equipped with video displays for passengers in back row seats. The inventive concept can be readily extended to an embodiment that the driver controls an operation of selecting a video file for a passenger in the back row seat. It will be understood that such alternatives and modifications fall into the scope of the present inventive concept.

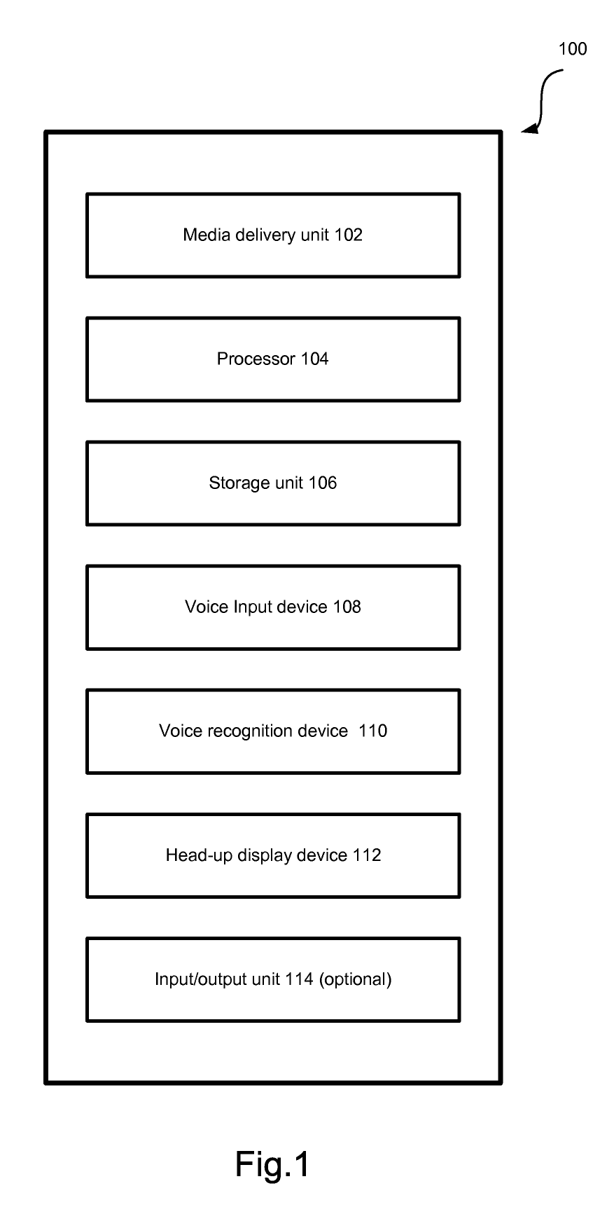

FIG. 1 is a schematic diagram illustrating an exemplary in-vehicle media delivery system 100. The media delivery system 100 comprises a media delivery unit 102. According to one implementation of the invention, the media delivery unit 102 comprises a speaker system. The speaker system may include multiple speakers installed in different locations of the vehicle. The media delivery system may further comprise one or more video display screens. The display screens may be installed in positions for passengers seated in seats of back rows.

The media delivery system 100 further comprises a processor 104. The processor 104 may pertain to be a microprocessor for controlling operations of the system. The processor 104 may further include other data processing units such as CODEC (Coder and Decoder). Media assets may be stored in a storage unit 106. The storage unit 106 may comprise flash memory devices and/or magnetic storage devices such as hard disk drivers. The storage unit 106 may also comprise optical storage devices such as CDs and/or DVDs.

A voice input device 108 is used to receive voice instructions from the user. The voice input device 108 may include a microphone. A voice recognition unit 110 is used to convert the received voice instructions into conventional instructions recognizable by the processor 104.

A HUD (Head-Up Display) 112 is used to display a list of user selectable items on the windshield of the automobile. A HUD is any transparent display that presents data without requiring the user to look away from his or her usual viewpoint. The HUD 112 comprises a “combiner” that is a windshield of the automobile according to one implementation of the present invention. The combiner may also be a dedicated transparent display. The display 112 further includes a projection unit installed in a suitable position of the automobile. Projection Units can be either below or above the combiner. The projection unit uses a Cathode Ray Tube, light emitting diode, micro-mirror array or liquid crystal display to project the image. The HUD 112 is controlled by the processor 104.

The in-vehicle media delivery system 100 may also include a conventional I/O device 114. The I/O device 114 may be implemented using a touch-screen display.

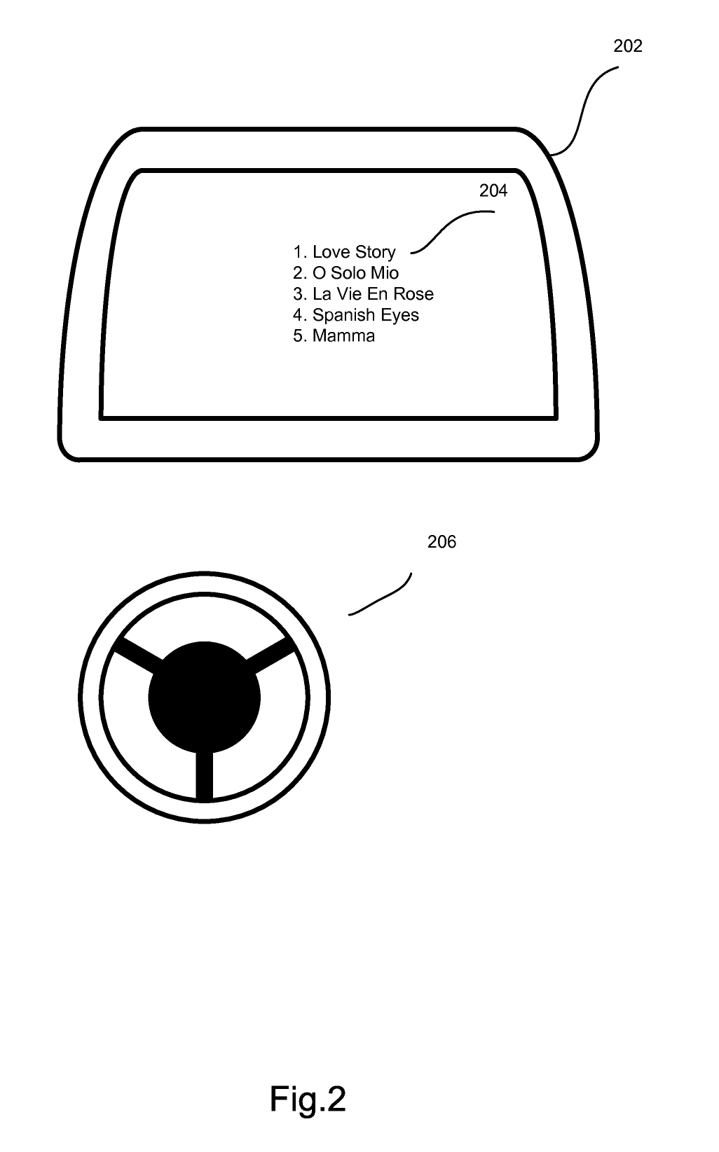

FIG. 2 is a schematic diagram illustrating that a list of metadata of the user selectable media assets is displayed on the windshield 202 of an automobile by employing the HUD device. The user may view the displayed content 204 without looking away from his or her view. A driving wheel 206 is also shown in the figure. Each displayed metadata of the media asset may be assigned a number in a sequential manner as illustrated. The user may read a number to select an associated media asset for playing back. According to another implementation, the user may also read one of the displayed metadata for his or her selection. The displayed metadata of media assets may also be associated with any other symbol that is readable by the user.

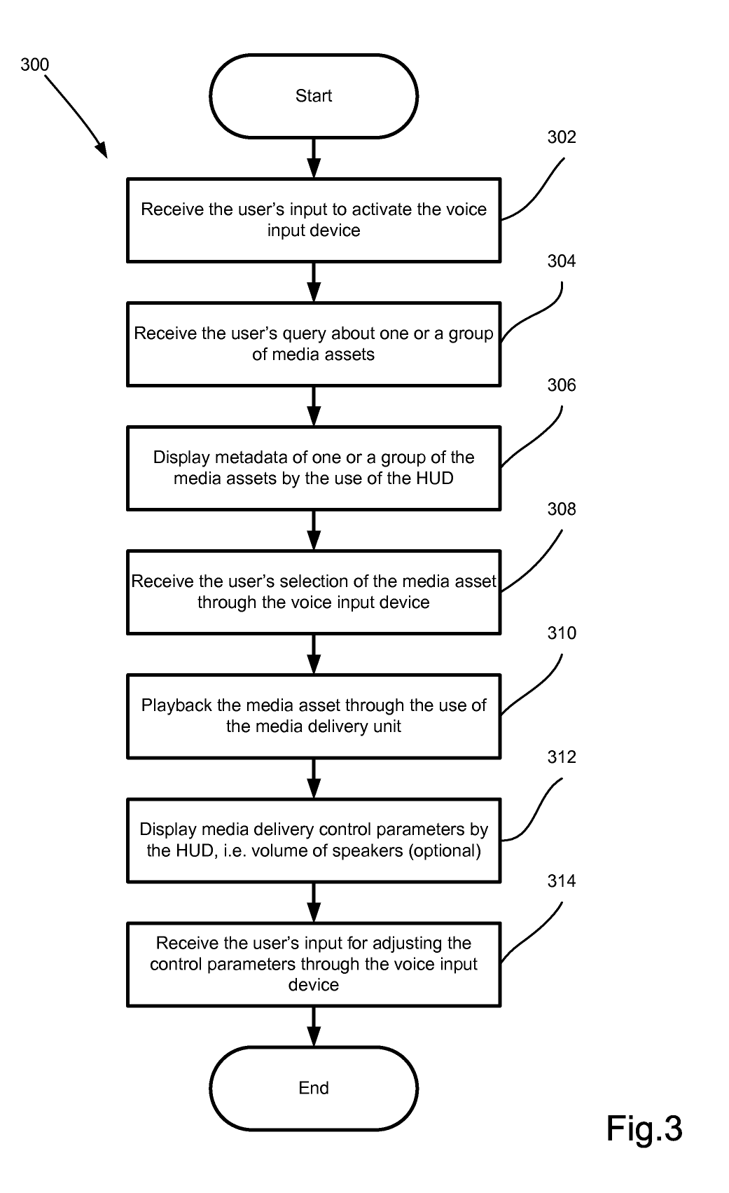

FIG. 3 is a flowchart illustrating the operation of the in-vehicle media delivery system 100. Process 300 starts with step 302 that the system 100 receives the user's instruction to activate the voice input device 108. In step 304, a voice query about a media asset or a group of media assets is received from the user. A list of metadata of the media assets is then displayed on the windshield using the HUD 112 in step 306. The user's selection of the media asset is received by the voice input device 108 in step 308. The displayed metadata of the media assets may be numbered in a sequential manner. The user may read a number associated with a specific media asset and make the selection. In step 310, the selected media asset is played back through the use of the media delivery unit 102. A list of media delivery control parameters such as the volume of the speaker system may be displayed in step 312. The user may use his or her voice to adjust the control parameters in step 314.

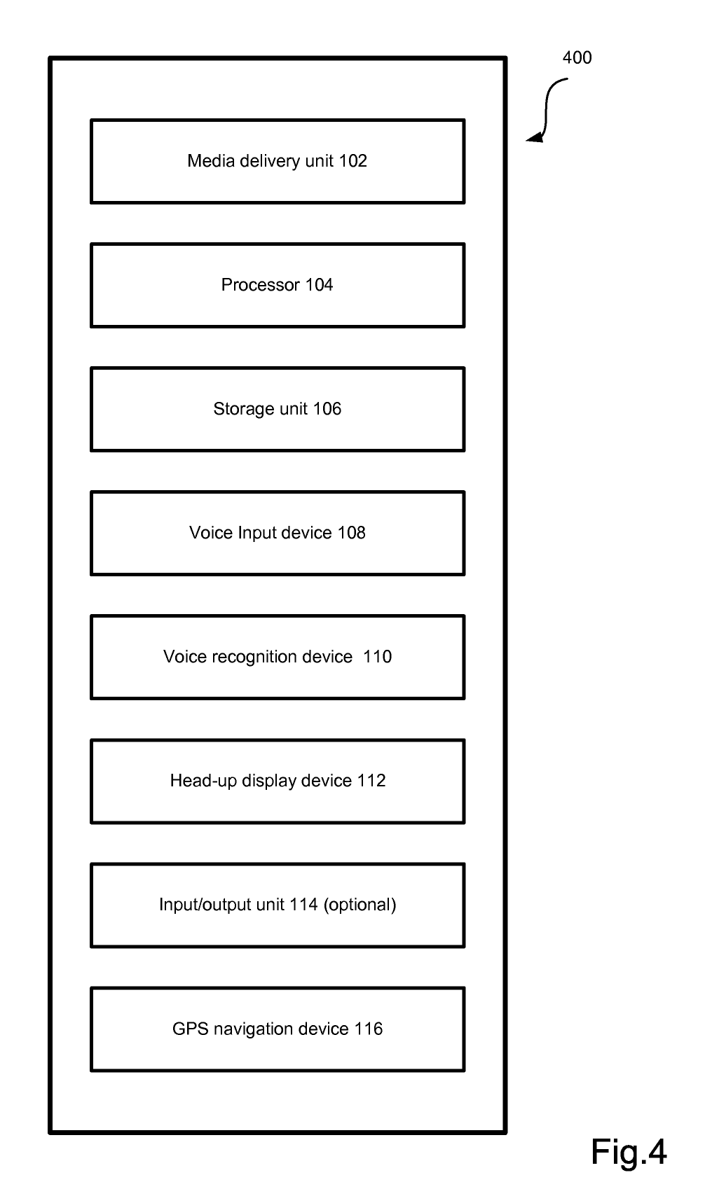

FIG. 4 is a schematic diagram illustrating an exemplary in-vehicle media delivery system 400 including a GPS navigation device 116. A driving route may be displayed on the windshield by the use of the HUD 112 and of the GPS navigation device 116. The user may choose to operate the system either as a media player or as a GPS navigation system. The selection may be conducted through the use of the voice input device 108. The selection may also be conducted through the use of a conventional input device. The system may also be used to display a driving route while a selected media asset is being played back.

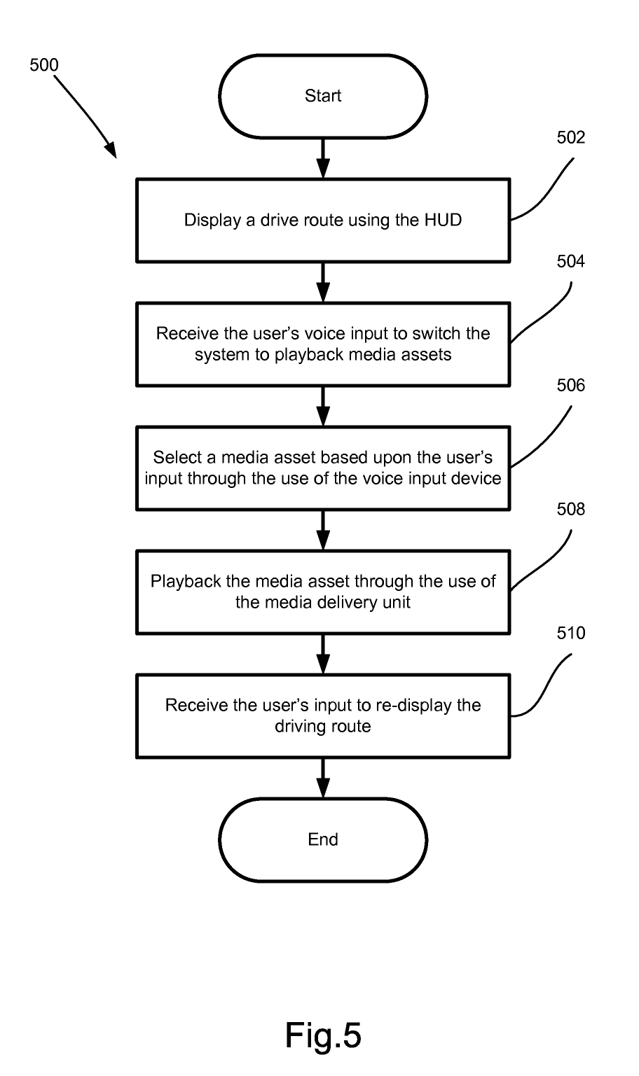

FIG. 5 is a flowchart illustrating the operation of the in-vehicle media delivery system 400 including GPS navigation device 116. Process 500 starts with step 502 that system 400 is operated as a GPS navigation system by displaying a driving route using the HUD 112. The voice input device 108 is activated by the user if it has not been activated. The user's instruction is received in step 504 to switch the system into a media player. At least one media asset is selected in step 506 by using the voice input device 108. Subsequently, the selected media asset is played back in step 508 through the use of the media delivery unit 102. The updated driving route may be re-displayed in step 510 after receiving the user's instruction.

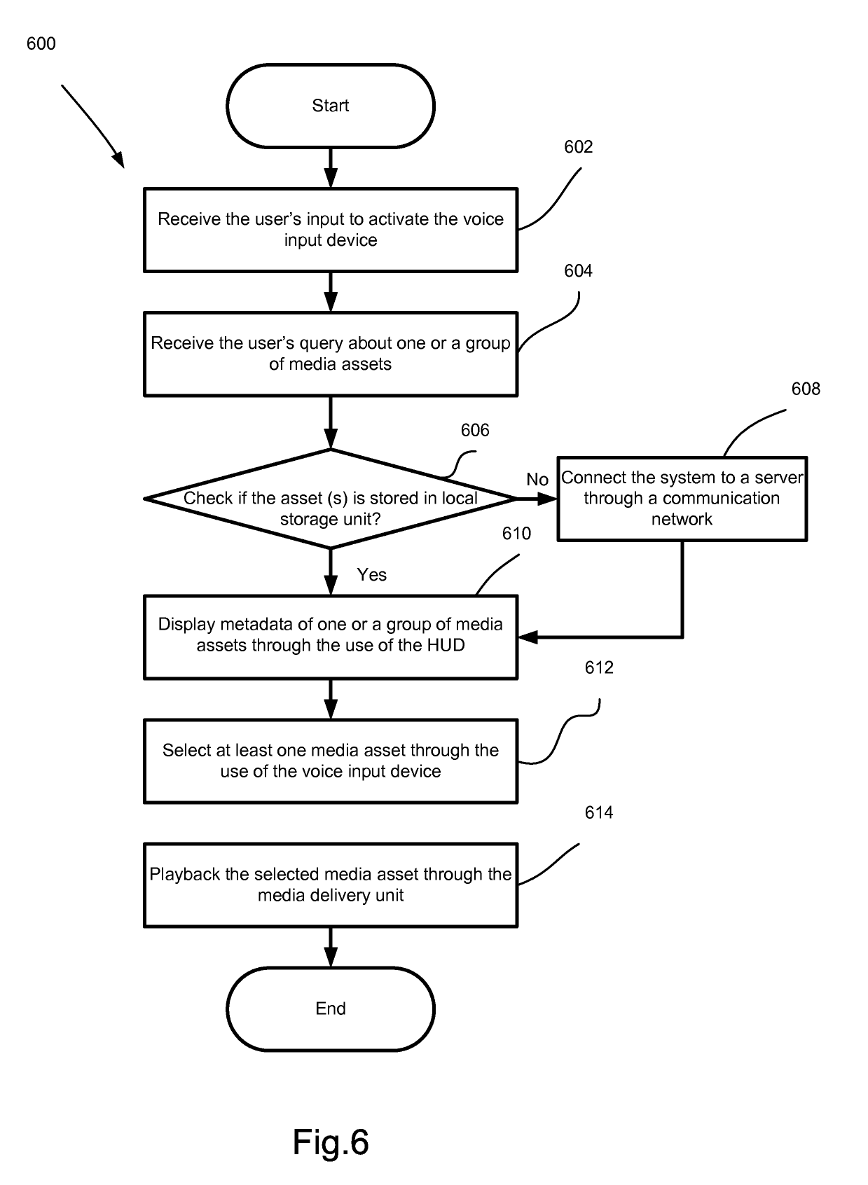

FIG. 6 is a flowchart illustrating the operation of the in-vehicle media delivery system 100 connected to a server through the Internet. Process 600 starts with step 602 that the voice input device 108 is activated after the user's instruction is received. The user's query about one or a group of media assets is received in step 604. In step 606, the processor checks if the requested media asset or assets are stored in the storage unit of the system. If the result is negative, the system is connected to a server in a communication network in step 608. According to one implementation, the communication network is the Internet. If the result is positive in step 606, the metadata of the media asset or assets is displayed in step 610 on the windshield of the automobile. Because the media assets may also be transferred from the server to the system through the communication network, the displayed media asset metadata may comprise the media assets stored in local storage unit and the assets stored in the server. In step 612, at least one media asset is selected though the use of the voice input device 108. In step 614, the selected media asset is played back by using of the media delivery unit 102. The user may need to purchase the selected media asset if the asset is not own by the user. The purchase process may be completed through an on-line facility. The purchasing information such as the purchasing price may be displayed on the windshield using the HUD 112. The purchasing information may also be delivered to the user through the speaker system.

While the invention has been disclosed with respect to a limited number of embodiments, numerous modifications and variations will be appreciated by those skilled in the art. It is intended that all such variations and modifications fall with in the scope of the following claims:

1. A media delivery system for a vehicle comprising:
a. a media delivery unit;
b. a processor;
c. a storage unit;
d. a voice input device for receiving a user's voice inputs;
e. a voice recognition unit; and
f. a head-up display unit,
wherein the head-up unit displays metadata of one or a plurality of media assets after the user's input for a media asset is received by the voice input device.

2. The system as recited in claim 1, wherein said vehicle including an automobile.

3. The system as recited in claim 1, wherein said system further comprising a communication unit for connecting said system to a communication network.

4. The system as recited in claim 1, wherein said system further comprising a non-voice activated input device.

5. The system as recited in claim 1, wherein said system further comprising a GPS (Global Positioning System) navigation device.

6. The system as recited in claim 1, wherein said head-up display further comprising a means of displaying a driving route.

7. The system as recited in claim 1, wherein said media delivery unit further comprising a speaker system.

8. A method of delivering a media asset through a media delivery system to a user of a vehicle, the method comprising:
a. receiving the user's voice input by a voice input device for playing back a media asset;
b. displaying metadata of one or a plurality of media assets by utilizing a head-up display device; and
c. playing back at least one media asset after receiving, by using the voice input device, the user's selection.

9. The method as recited in claim 8, wherein said vehicle including an automobile.

10. The method as recited in claim 8, wherein at least one of the media assets is stored in a storage unit of the media delivery system.

11. The method as recited in claim 8, wherein at least one of the media assets is stored in a server connected to the media delivery system through a communication network.

12. The method as recited in claim 11, wherein said communication network comprising the Internet.

13. The method as recited in claim 8, wherein said method further comprising a step of purchasing a media asset before the asset is played back.

14. A method of delivering a media asset and/or a driving route to a user of an automobile through the use of a system comprising a voice input device, a voice recognition device, a GPS navigation device, and a head-up display device, the method comprising:
a. displaying a driving route by utilizing the head-up display device;
b. receiving the user's input for playing back one or a plurality of media assets;
c. displaying metadata of at least one media asset; and
d. playing back the media asset after receiving the user's selection through the voice input device.

15. The method as recited in claim 14, wherein said method further comprising a step of removing displayed driving route before the metadata of media asset (s) is displayed.

16. The method as recited in claim 14, wherein said method further comprising a step of re-displaying the driving route while the media asset is being played back.

17. The method as recited in claim 14, wherein at least one of the media assets is stored in a storage unit of said system.

18. The method as recited in claim 14, wherein at least one of the media assets is stored in a server connected to the system through a communication network.

19. The method as recited in claim 18, wherein said communication network comprising the Internet.

20. The method as recited in claim 14, wherein said method further comprising a step of purchasing a media asset before the asset is played back.
